(19) United States
(12) Patent Application Publication
(10) Pub. No.: US 2024/0083273 A1
(43) Pub. Date: Mar. 14, 2024

(54) SUPPLY CABLE WITH GESTURE CONTROL

(71) Applicant: Robert Bosch GmbH, Stuttgart (DE)

(72) Inventor: Michael Scholl, Backnang (DE)

(21) Appl. No.: 18/467,676

(22) Filed: Sep. 14, 2023

(30) Foreign Application Priority Data
Sep. 14, 2022 (DE) 10 2022 209 623.1

(51) Int. Cl. B60L 53/18; B60L 53/16; B60L 53/62; B60L 53/64

(52) U.S. Cl. CPC B60L 53/18; B60L 53/16; B60L 53/62; B60L 53/64; B60L 2250/10

(57) ABSTRACT

The present invention relates to a supply cable (1) for transmitting electrical energy to or from a vehicle (2), the supply cable (1) comprising at least one connector (3, 4) for connecting the supply cable (1) to a vehicle (2) and/or a charging port (5) and/or a consumer (6), and a sensor (7) for detecting accelerations and/or rotation rates, wherein the supply cable (1) is configured to detect a spatial position and/or movement of a partial area of the supply cable (1) with the aid of the sensor (7), in particular of the connector (3, 4), and to set an operating mode of the supply cable (1) as a function of the detected position and/or movement.

### BACKGROUND

The present invention relates to a supply cable for transmitting electrical energy. The invention also relates to a connector for a supply cable. The invention also relates to a method for operating a supply cable.

Charging cables that enable a vehicle to be connected to a charging infrastructure are known from the prior art. The vehicle has a storage unit for storing electrical energy, which is to be charged by the charging infrastructure. For example, the vehicle is an electric vehicle or a plug-in hybrid vehicle. The charging station is, for example, a wallbox or charging station or even a household socket.

The supply cable has the option of limiting an electrical current flowing through the supply cable, particularly if charging is to take place at a household socket. A slide switch, for example, is provided for this purpose.

A supply cable of this type is known from DE 10 2021 206 601 A1.

### SUMMARY

The supply cable according to the invention makes it possible to set an operating mode simply and intuitively for a user. In particular, no input device, e.g. in the form of a keyboard or a switch, a joystick, a touch display or the like, is required for this; instead, the operating mode is set by moving or changing the position of a partial area of the supply cable. Depending on the movement and/or position, e.g. using one or more predefined gestures, different inputs can be made. This is particularly advantageous for supply cables, as no input devices need to be provided as housing openings. The supply cable can therefore be manufactured easily and cost-effectively, is particularly easy to design to be media-tight and enables reliable operation.

The supply cable is intended for transmitting electrical energy to a vehicle, in particular from a charging source. Alternatively or additionally, the supply cable is provided for transmitting electrical energy from the vehicle to a consumer, which can be, for example, another vehicle, the power grid, a household appliance or the like. The supply cable has at least one connector for connecting the supply cable to a vehicle and/or a charging port and/or a consumer. The supply cable also has a sensor for detecting accelerations and/or rotation rates. The supply cable is configured to use the sensor to detect the spatial position and/or movement of a partial area of the supply cable, in particular the connector. In addition, the supply cable is configured to set an operating mode of the supply cable depending on the detected position and/or movement.

The determination of the spatial position and/or the movement and the setting of the operating mode are preferably carried out by a computing device. The computing device is part of the supply cable in particular, but can also be an external computing device, for example in a cloud. In such a case, it can be provided that the supply cable transmits data from the sensor and receives further data for setting the operating mode.

The charging port is any component that provides electrical power. For example, the charging port can be configured as a wallbox and/or a charging station and/or a household socket and/or a three-phase socket or similar. In particular, the supply cable has a suitable connector for the respective charging port.

In particular, the sensor is an acceleration sensor and/or an inertial sensor. The sensor is particularly used to determine accelerations and/or changes in accelerations. Preferably, the movement of the part of the supply cable to be detected, in particular the connector, is not a uniform movement.

In particular, the operating mode is set depending on the detected movements of a partial area of the supply cable. In this way, one or more different movements or movement patterns or movement sequences or gestures can be executed with the monitored parts of the supply cable or the monitored part of the supply cable can be transferred to different spatial positions (e.g. straight, inclined upwards, inclined downwards, rotated by 180°, etc.), which lead to a changed operating mode after detection.

It is particularly advantageous that the operating mode is only set if authentication has taken place beforehand. In particular, it is intended that a user must first authenticate himself in order to set an operating mode. In this way, unintentional adjustment of the operating mode due to accidental cable movement is avoided or at least made more difficult. Authentication can be wireless or contactless, e.g. via an NFC chip or a Bluetooth® connection or via a mobile phone connection or optical recognition of the user. However, it can also be done by touch (e.g. using a fingerprint sensor) or by entering a code or similar.

The supply cable can, for example, have a single connector, preferably for connecting to a vehicle, or it can, for example, have two connectors.

The supply cable can also have a connecting line that is connected to the at least one connector in a detachable or non-detachable manner. If two connectors are provided, the connecting line can be arranged between the two connectors and connected to the two connectors in a detachable or non-detachable manner. In the case of a charging station such as a wallbox, for example, the connecting line can be permanently or detachably connected to the charging station or attached to it and have a connector at its end on the vehicle side.

It is understood that the supply cable can have exactly one single sensor. However, it can also be provided that the supply cable has a plurality of sensors, e.g. at least one of the sensors can be configured as an acceleration sensor for a spatial direction and/or at least one of the sensors can be configured as a rotation rate sensor, for example.

The term “comprise” is to be understood as synonymous with the term “have”, unless otherwise stated.

The dependent claims specify preferred further developments of the invention.

Preferably, setting the operating mode comprises setting and/or increasing and/or decreasing an amount of electrical power and/or electrical energy to be transmitted via the supply cable. Alternatively or additionally, setting the operating mode comprises setting and/or increasing and/or decreasing one or more of the following:
a time at which the charging or discharging process should begin or end,
charging thresholds or discharging thresholds at which a user is notified,
electricity price thresholds below which the vehicle is charged or above which the vehicle is discharged.

In particular, a maximum charging current and/or a charging quantity can be specified in this way (and/or a time for the start and/or end of the charging or discharging process; and/or charging thresholds, on reaching which a user is notified, e.g. on a mobile end device; and/or at least one electricity price threshold, on falling below which a charging process is started or on exceeding which a discharging process is started).

An “increase” in electrical power and/or amount of electrical energy is also to be understood as a switch-on process, as this involves an increase starting from a base value such as the value 0, which represents the switched-off state. The same also applies to the reduction, as the reduction of the electrical power and/or amount of electrical energy also comprises a reduction to the base value, for example 0, and thus a switch-off.

Preferably, the operating modes can be implemented differently. For example, when charging the vehicle at a household socket, it is possible to actively influence an electrical current flowing through the supply cable and/or an applied electrical voltage. This can, for example, prevent a power line or the power line fuse from being overloaded. This means that the supply cable actively intervenes in the current limitation, for example by communicating with the vehicle and limiting the charging power or by limiting the charging power itself. Alternatively or additionally, it is provided that an operating mode, in particular a maximum charging quantity and/or a maximum charging current and/or a time at which the charging process or discharging process is to begin or end and/or charging thresholds or discharging thresholds at which a user is notified and/or electricity price thresholds below which (or above which) the vehicle is to be charged (or discharged), is set by communication between the supply cable and the vehicle and/or the charging port and/or the consumer. This is particularly advantageous if the vehicle is charged at a charging station or wallbox. In this case, the charging station or wallbox itself usually takes the charging current and charging quantity into account, wherein the values to be specified are communicated by the supply cable. In this case, the supply cable itself does not necessarily have to actively intervene in the current flow. By setting start and/or end times, a particularly favorable electricity tariff can be used advantageously and/or an overload in the electricity grid can be prevented. By setting electricity price thresholds, favorable tariffs can be used for charging and/or discharging and in this way the costs for the vehicle can be optimized.

The examples given are merely examples. Other operating modes can also be provided, which are set depending on the detected position and/or movement.

In particular, the connector has a connector housing. It is intended that the sensor is arranged in an interior of the connector housing. The sensor is therefore used in particular to detect movement and/or the spatial position of the connector. Advantageously, the sensor is particularly well protected against external influences such as gases or liquids due to its arrangement inside the housing, which means that the sensor can have a particularly long service life. Due to the arrangement in the interior, the housing can also be simplified. It is particularly advantageous that no further moving parts are required as an interface to the external space (such as dials or sliders or knobs or buttons) in order to effect an input of the operating mode. At the same time, a user can also make operating mode settings without a separate element such as a cell phone, tablet or similar, which considerably simplifies operability. For example, the connector can simply be moved into a different position (e.g. rotated) or it can be moved in a certain way (e.g. gestures can be performed with the connector), which then leads to a change in the operating mode of the supply cable. This is a very intuitive and simple way for a user to set the operating mode, as the user has to pick up the connector anyway to establish an electrical connection with the vehicle or charging port or consumer.

Preferably, the supply cable is configured or set up to increase a charging current to be conducted through the supply cable, in particular by a predefined amount, during a first predefined movement, in particular of the connector. Alternatively or additionally, the supply cable is configured or set up to reduce a charging current to be conducted through the supply cable, in particular by a predefined amount, during a second predefined movement, in particular of the connector. In this way, the user can easily and conveniently set the desired charging current. In particular, the supply cable is configured to store a last setting of the charging current by the user and to provide it for a subsequent further charging process.

Similarly, in an alternative embodiment, the same movements (or two other movements respectively) can be used to set, increase or decrease: e.g. times for the start and/or end of the charging process; amounts of electrical energy for charging the vehicle or discharging the vehicle; at least one energy threshold value, on reaching which the user is notified; at least one electricity price threshold, on falling below which the charging process begins and/or on exceeding which the charging process ends; at least one electricity price threshold, on exceeding which the discharging process begins and/or on falling below which the discharging process ends.

This makes it particularly easy for the user to intuitively, quickly and reliably make the usual settings without having to operate any other controls. This can be very helpful and comfortable at night, in the rain, snow or cold, for example, or when carrying shopping bags or similar items in one hand.

The connector advantageously has a plug face. The plug face defines the insertion direction of the connector. For example, the plug face has protruding pins or mating pins, wherein the pins or mating pins have an orientation that corresponds to the insertion direction. The connector must be connected to the vehicle and/or the charging port along the insertion direction and/or the consumer must be connected to the connector. It is further provided that the first predefined movement is a pivoting of the connector in a first direction substantially perpendicular to the insertion direction. Alternatively or additionally, the second predefined movement is a pivoting of the connector in a second direction, which is opposite to the first direction. This means that different and distinctly different movements are available to set the operating mode. In particular, it is provided that the first predefined movement causes an increase in the charging current due to the upward swivel, while the second predefined movement causes a reduction in the charging current due to the downward swivel.

It is understood that lateral movements (left/right) or other movement patterns can also be provided in order to change the operating mode or influence another parameter (see above, e.g. clock times, notification thresholds, electricity price thresholds, etc.).

The sensor is preferably configured to detect a position and/or movement in relation to an axis or in relation to several axes. This makes it easy to reliably detect different spatial positions and/or different movements. The sensor is particularly advantageously configured as a MEMS sensor. Such a micro-electro-mechanical system is ideal for implementing a sensor as described. The advantage of this type of sensor is that it is very small, can be manufactured very cost-effectively, is particularly easy to mount on a circuit board, e.g. as a surface-mounted device (SMD), and is also robust and reliable. The sensor is preferably a rotation rate sensor and/or an acceleration sensor.

Preferably, the supply cable, in particular at least one connector, has an output unit. The output unit is configured to output the operating mode. In particular, the output unit is configured to emit an acoustic and/or visual and/or haptic signal when the operating mode changes. The user can therefore quickly, reliably and safely recognize which operating mode is currently set or which change it has caused. This means that a desired operating mode can be reliably set and used.

The output unit has at least one light-emitting diode, which is particularly advantageous. In particular, there are several light-emitting diodes and, advantageously, several light-emitting diodes of different colors. The LEDs can advantageously display the set charging current, wherein for example, with one LED being switched on or off with each gesture performed, depending on whether the charging current is increased or decreased. Alternatively or additionally, the output unit has a display. The display is used in particular to output text and/or graphics and/or symbols. The display can be a touchscreen, for example, wherein in addition to changing the operating mode by movement, it is also possible to set it via the touchscreen.

Advantageously, the supply cable has a primary connector for connecting the supply cable to the vehicle. The supply cable also has a secondary connector for connecting the supply cable to a charging port or a consumer. The primary connector has a primary connector housing and the secondary connector has a secondary connector housing. It is intended that the sensor is arranged in the primary connector housing and/or in the secondary connector housing. In this way, a spatial position of the primary connector and/or the secondary connector can be detected safely and reliably and/or movements of the primary connector and/or secondary connector can be detected advantageously. The arrangement of the sensor in the primary connector housing or in the secondary connector housing advantageously increases the service life of the sensor, as it is particularly well protected in the respective housing. The spatial position and/or movement can also be detected particularly well, as the sensor is mechanically connected to the respective connector in this way.

It is particularly advantageous for the supply cable to detect the spatial position and/or movements at the primary connector. In particular, this only takes place if there is already a connection between the secondary connector and the charging port and/or the consumer. Thus, before connecting the primary connector to the vehicle, a desired operating mode can advantageously first be set by means of the detected spatial position and/or the detected movement, wherein the operating mode is set, for example, by means of the position and/or by means of movement of the primary connector. In particular, an existing connection to the charging port already ensures a power supply for the components of the supply cable itself. Otherwise, the supply cable is preferably equipped with an energy storage device, such as a battery. Another advantage is that this prevents the operating mode from being inadvertently adjusted or changed. This could occur, for example, with a secondary connector that is not yet connected to the charging port or consumer by handling the supply cable or handling the connector when preparing the connection process, e.g. when the supply cable is unpacked from the trunk of a vehicle or is untangled.

The invention also relates to a charging infrastructure. The charging infrastructure has a base module for providing electrical energy and a supply cable as described above. It is provided that the connector is a primary connector for connecting the supply cable to the vehicle, wherein the primary connector is coupled to the base module via an electrical connecting line. In particular, the base module has all the functions for providing electrical power and controlling a charging process. The base module is, for example, a wallbox or a charging station. In particular, settings for the charging process can also be made on the base module. The connecting line is preferably hard-wired to the base module, i.e. the connection between the connecting line and the base module cannot be disconnected—and if so, only by a specialist. In particular, the base module is connected to a power grid and can therefore supply electrical energy for charging the vehicle or absorb electrical energy from the vehicle. All components of the base module can also be supplied with electrical power, making it easy and inexpensive to set the operating mode by moving the primary connector. A user of the charging infrastructure can therefore set an operating mode on the primary connector and does not have to resort to the base module.

The invention also relates to a connector of a supply cable for transmitting electrical energy to or from a vehicle. The connector is configured to connect the supply cable to a vehicle and/or a charging port and/or a consumer. It is also provided that the connector has at least one sensor for detecting a spatial position and/or a movement. The supply cable is configured or set up to detect a spatial position and/or movement of a partial area of the supply cable, in particular the connector, by means of the sensor. In addition, the supply cable is configured to set an operating mode of the supply cable depending on the recognized or detected position and/or movement. In particular, the functions and advantages described above for the supply cable are provided in the connector itself.

The invention also relates to a method for operating a supply cable. The supply cable is used to transmit electrical energy to or from a vehicle and has at least one connector. The connector is intended for connecting the supply cable to a vehicle and/or a charging port and/or a consumer. The supply cable also has a sensor for detecting accelerations and/or rotation rates. The method comprises the following steps:
detection of a spatial position and/or movement of a partial area of the supply cable by means of the sensor. This partial area can be a connector of the supply cable, for example;
setting an operating mode of the supply cable depending on the detected position and/or movement. The method allows a desired operating mode to be set simply, intuitively, quickly and reliably.

Preferably, setting the operating mode comprises setting and/or increasing and/or decreasing an amount of electrical power and/or electrical energy to be transmitted via the supply cable. Alternatively or additionally, adjusting the operating mode comprises adjusting and/or increasing and/or decreasing one or more of the following:
an amount of electrical power and/or electrical energy to be transmitted via the supply cable 1,
a time at which the charging or discharging process should begin or end,
charging thresholds or discharging thresholds at which a user is notified,
electricity price thresholds below which the vehicle is charged or above which the vehicle is discharged All these parameters would otherwise have to be set using buttons and/or sliders and/or other input devices. The spatial position and/or a (defined) movement or a (defined) movement pattern, e.g. a defined gesture of the supply cable, provides a simple and reliable way of dispensing with such input devices.

The method therefore makes it possible to set important charging or discharging parameters in a simple, intuitive, fast and reliable way.

### BRIEF DESCRIPTION OF THE DRAWINGS

Embodiment examples of the invention are described in detail in the following with reference to the accompanying drawing. The drawings include:

FIG. 1 is a schematic representation of a supply cable according to an embodiment example of the invention,

FIG. 2 is a schematic representation of a connector of the supply cable according to the embodiment example of the invention,

FIG. 3 a schematic representation of a first movement of the connector of the supply cable according to the embodiment example of the invention,

FIG. 4 a schematic representation of a second movement of the connector of the supply cable according to the embodiment example of the invention, and

FIG. 5 is a schematic representation of a charging infrastructure according to an embodiment example of the invention.

### DETAILED DESCRIPTION

FIG. 1 schematically shows a supply cable 1 according to an embodiment example of the invention, wherein a method according to an embodiment example of the invention can be carried out with the supply cable 1. The supply cable 1 is used to electrically connect a vehicle 2 to a charging port 5. Alternatively, the supply cable 1 can be used to connect the vehicle 2 to a consumer 6 in order to draw energy from the vehicle 1 and operate the consumer 6. The consumer 6 can also be another vehicle, for example, which is to be made roadworthy again using energy from the vehicle 2 (breakdown assistance). The vehicle 2 is in particular an electric vehicle or hybrid vehicle and the charging port 5 is preferably a charging station or wallbox, but can also be a household socket or another interface for obtaining electrical energy.

The charging cable 1 has a primary connector 3 and a secondary connector 4. The primary connector 3 is used for the electrical connection to the vehicle 2. The secondary connector 4 is used for the electrical connection with the charging port 5. An alternative secondary connector 4′ is used for the electrical connection to a consumer 6. The primary connector 3 and the secondary connector 4 are electrically connected via an electrical line section or a connecting line 11 of the charging cable 1, wherein the line section or the connecting line 11 is connected to the primary connector 3 and the secondary connector 4 in a separable or non-destructively detachable manner.

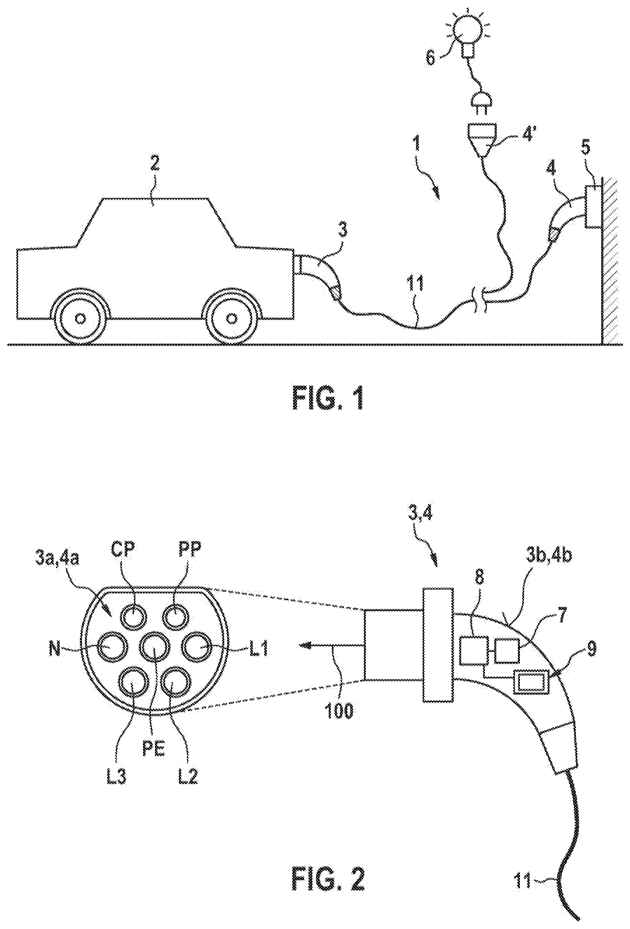

FIG. 2 schematically shows a connector 3, 4 of the charging cable 1, wherein the connector 3, 4 can be the primary connector 3 or the secondary connector 4. As described above, the connector 3, 4 is either permanently or detachably connected to the cable section or the connecting line 11 and is also used for the electrical contacting of vehicle 2 or charging infrastructure 3.

FIG. 2 shows an example of the plug face 3a, 4a of a type 2 plug connection. In addition to a protective conductor PE, a first outer conductor L1, a second outer conductor L2, a third outer conductor L3 and a neutral conductor N, a control pilot CP and a proximity pilot PP are also provided. In particular, the Control Pilot CP is used to agree a charging current between vehicle 2 and charging infrastructure 3. The plug face 3a, 4a defines an insertion direction 100 of the connector 3, 4. Instead of the plug face 3a, 4a of a type 2 plug connection shown as an example, the connector 3, 4 can also have other plug faces 3a, 4a, such as a Schuko® plug or a CEE plug. In all cases, however, an insertion direction 100 is defined by the plug face 3a, 4a.

The connector 3, 4 also has a connector housing 3b, 4b. In particular, a sensor 7 is arranged in an interior of the connector housing 3b, 4b, which is configured to detect accelerations and/or rotation rates. In this way, a movement of the connector 3, 4 can be detected.

For example, the supply cable 1 has a computing unit 8. The computing unit 8 is arranged in the connector housing 3b, 4b. The computing unit 8 can also be configured to be distributed over a primary connector housing 3b of the primary connector 3 and a secondary connector housing 4b of the secondary connector 4. The computing unit 8 is configured to detect a spatial position and/or a movement by means of signals from the sensor 7 and to set or change operating modes of the supply cable 1 based on this or depending on the spatial position and/or the movement. In particular, the sensor 7 and an output unit 9 are connected to the computing unit 8. In particular, the output unit 9 indicates a currently set operating mode. It is also possible for the computing unit 8 and/or an authentication module not shown here to enable authentication of the user. It can be provided that only an authenticated user can set and/or change the operating modes by changing the position and/or movement of the connector 3, 4.

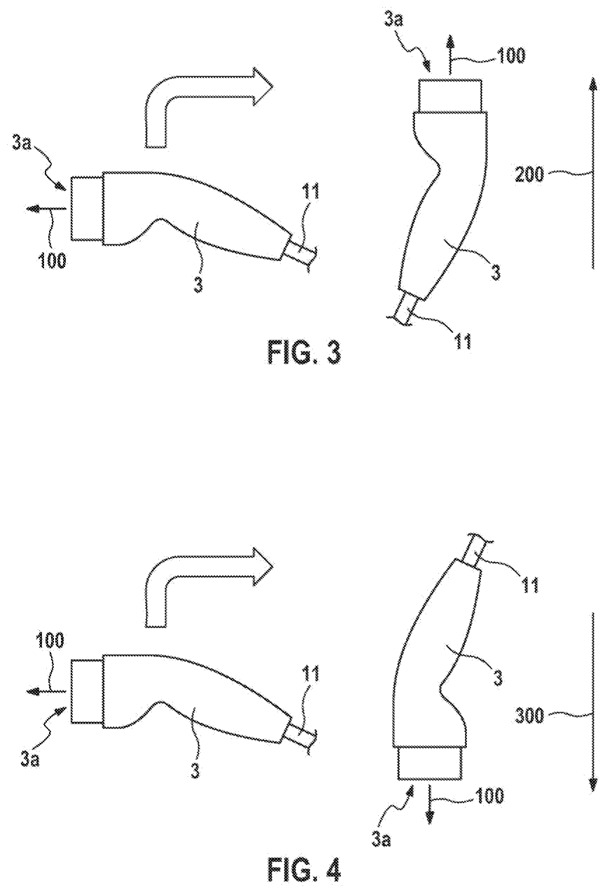

FIG. 3 and FIG. 4 schematically show possible movements for setting the operating mode. In both figures, only the primary connector 3 is shown as an example, wherein this could also be a secondary connector 4.

A first predefined movement shown in FIG. 3 is a pivoting of the primary connector 3 in a first direction 200 substantially perpendicular to the insertion direction 100. In the embodiment example, the primary connector 3 is thus pivoted upwards. In this way, a charging quantity and/or a charging current are increased in particular. Alternatively or additionally, this movement can also be used to adjust a time for a charging/discharging start and/or a charging/discharging stop. Alternatively or additionally, a threshold value (e.g. an energy amount threshold value or a temperature threshold value) can be changed or set, which notifies the user when it is reached, exceeded or undershot. Alternatively or additionally, an energy price can also be set, for example, which is to be used for a charging process start or charging process stop or discharging process start or discharging process stop. Other parameters that can be changed or set are also conceivable.

The first predefined movement or movement pattern can also be described as a gesture, for example. This gesture can be reliably recognized by the sensor 7, in particular an acceleration sensor or rotation rate sensor, in order to then increase the charging current and/or the charging quantity (or another parameter, see above), e.g. by a predefined step, e.g. by 0.5 A or by 1 A.

The second predefined movement is also a gesture and corresponds to pivoting the primary connector 3 in a second direction 300, which is opposite to the first direction 200. In the embodiment example, a downward swivel takes place. This leads, for example, to a reduction in the charging current and/or the charging quantity (or another parameter).

In particular, setting the operating modes via a spatial position and/or a movement, e.g. a gesture, is only possible if the secondary connector 4 is electrically connected to the charging port 5 in order to provide electrical power for the components of the supply cable 1.

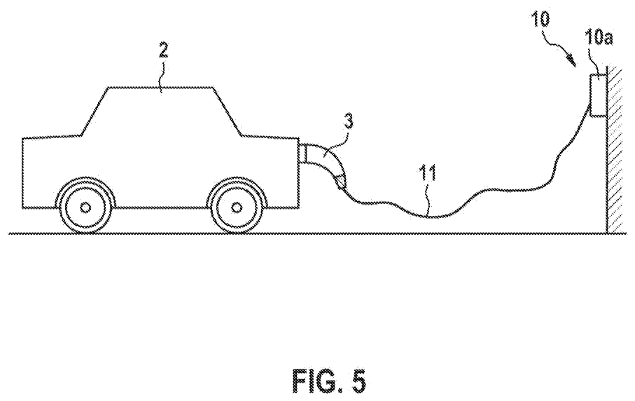

FIG. 5 shows another advantageous application case. Here is a charging infrastructure 10 with a base module 10a and a supply cable 1 permanently connected to it, wherein a connecting line 11 of the supply cable 1 is permanently wired to the base module 10.

The base module 10a is connected to a power grid in this example and has the logic required to control a charging process in this example. The supply cable 1 has a primary connector 3 as described above. The sensor 7 in the primary connector housing 3b can be used to determine the spatial position and/or movement of the primary connector 3. As described above, this allows operating modes to be set using only the position and/or movement of the primary connector 3, in particular without having to operate the base module 10a or an external input unit (e.g. a cell phone).

1. A supply cable (1) for transmitting electrical energy to or from a vehicle (2), wherein the supply cable (1) comprises:
at least one connector (3, 4) for connecting the supply cable (1) to a vehicle (2) and/or a charging port (5) and/or a consumer (6), and
a sensor (7) for detecting accelerations and/or rotation rates, wherein the supply cable (1) is configured
to detect a spatial position and/or movement of a partial area of the supply cable (1) by the sensor (7), and
to set an operating mode of the supply cable (1) depending on the detected position and/or movement.

2. The supply cable (1) according to claim 1,
wherein setting the operating mode comprises adjusting and/or increasing and/or decreasing one or more of the following:
an amount of electrical power and/or electrical energy to be transmitted via the supply cable (1),
a time at which the charging or discharging process should begin or end,
charging thresholds or discharging thresholds at which a user is notified,
electricity price thresholds below which the vehicle is charged or above which the vehicle is discharged.

3. The supply cable (1) according to claim 1, wherein the connector (3, 4) comprises a connector housing (3b, 4b), wherein the sensor (7) is arranged in an interior space of the connector housing (3b, 4b).

4. The supply cable (1) according to claim 1, wherein the supply cable (1) is configured:
to increase a charging current to be conducted through the supply cable (1) during a first predefined movement, and/or
to reduce a charging current to be conducted through the supply cable (1) during a second predefined movement.

5. The supply cable (1) according to claim 4, wherein the connector (3, 4) has a plug face (3a, 4a) which defines an insertion direction (100) of the connector (3, 4), and
the first predefined movement is a pivoting of the connector (3, 4) in a first direction (200) substantially perpendicular to the insertion direction (100),
and/or
the second predefined movement is a pivoting of the connector (3, 4) in a second direction (300) which is opposite to the first direction (200).

6. The supply cable (1) according to claim 1, wherein the sensor (7) is configured to detect a position and/or movement with respect to one axis or with respect to several axes.

7. The supply cable (1) according to claim 1,
wherein the supply cable (1) has an output unit (9),
wherein the output unit (9) is configured to output the operating mode, and
wherein the output unit is configured to emit an acoustic and/or optical and/or haptic signal when the operating mode changes.

8. The supply cable (1) according to claim 7,
wherein the output unit (9) has at least one light-emitting diode, and/or
wherein the output unit (9) has a display, in particular for outputting text and/or graphics and/or symbols.

9. The supply cable (1) according to claim 1, wherein the supply cable (1) comprises:
a primary connector (3) for connecting the supply cable (1) to the vehicle (2), and
a secondary connector (4) for connecting the supply cable (1) to a charging port (5) or a consumer (6), wherein the primary connector (3) has a primary connector housing (3b), wherein the secondary connector (4) has a secondary connector housing (4b), and
wherein the sensor (7) is arranged in the primary connector housing (3) and/or in the secondary connector housing (4).

10. The supply cable (1) according to claim 9,
wherein the supply cable (1) is configured to detect the spatial position and/or movements at the primary connector (3).

11. A charging infrastructure (10) comprising
a base module (10a) for providing electrical energy, and
a supply cable (1) according to claim 1, wherein the connector (3, 4) is a primary connector (3) for connecting the supply cable (1) to the vehicle (2), and wherein the primary connector (3) is coupled to the base module (10a) via an electrical connecting line (11).

12. A connector (3, 4) of a supply cable (1) for transmitting electrical energy to or from a vehicle (2),
wherein the connector (3, 4) is configured to connect the supply cable (1) to a vehicle (2) and/or a charging port (5) and/or a consumer (6) and has the following features
at least one sensor (7) for detecting a spatial position and/or a movement
wherein the supply cable (1) is configured,
to detect a spatial position and/or movement of a partial area of the supply cable (1) by the sensor (7), and
to set an operating mode of the supply cable depending on the detected position and/or movement.

13. A method of operating a supply cable (1) for transmitting electrical power to or from a vehicle (2), wherein the supply cable (1) comprises:
at least one connector (3, 4) for connecting the supply cable (1) to a vehicle (2) and/or a charging port (5) and/or a consumer (6)
a sensor (7) for detecting accelerations and/or rotation rates, wherein the method comprises the following steps:
detecting a spatial position and/or movement of a partial area of the supply cable (1) by means of the sensor (7),
setting an operating mode of the supply cable (1) depending on the detected position and/or movement.

14. The method according to claim 13, wherein setting the operating mode comprises adjusting and/or increasing and/or decreasing one or more of the following:
an amount of electrical power and/or electrical energy to be transmitted via the supply cable (1),
an amount of electrical power and/or electrical energy to be transmitted via the supply cable (1),
a time at which the charging or discharging process should begin or end,
charging thresholds or discharging thresholds at which a user is notified,
electricity price thresholds below which the vehicle is charged or above which the vehicle is discharged.

15. The supply cable (1) according to claim 1, wherein the partial area of the supply cable (1) is the connector (3, 4).

16. The supply cable (1) according to claim 6, wherein the sensor (7) is a MEMS sensor.

17. The supply cable (1) according to claim 10, wherein the supply cable (1) is configured to detect the spatial position and/or movements at the primary connector (3) only if a connection already exists between the secondary connector (4) and the charging port (5) and/or the consumer (6).
